(19) United States
(12) Patent Application Publication
(10) Pub. No.: US 2026/0147896 A1
(43) Pub. Date: May 28, 2026

(54) PRIORITIZING SECURITY VULNERABILITIES IN COMPUTING ECOSYSTEMS

(71) Applicant: Optum, Inc., Minnetonka, MN (US)

(72) Inventors: Guanghui CHEN, Eagan, MN (US); Brett P. STRINGHAM, Kaysville, UT (US)

(21) Appl. No.: 18/958,676

(22) Filed: Nov. 25, 2024

(51) Int. Cl. G06F 21/57

(52) U.S. Cl. CPC G06F 21/577; G06F 2221/034

(57) ABSTRACT

Various embodiments of the present disclosure provide security vulnerability detection and remediation infrastructure for a computing ecosystem that improves the functionality of a computing ecosystem in various aspects. The techniques comprise receiving a security vulnerability detection for a computing ecosystem, determining a vulnerability graph for the computing ecosystem that defines a set of component nodes, a set of vulnerability nodes, and a set of graph edges, determining a degree measure and a betweenness measure for a vulnerability node of the plurality of vulnerability nodes within the vulnerability graph, determining a set of prioritized vulnerability nodes from the vulnerability graph based on the degree measure and the betweenness measure, comparing the results derived from using different methods, and providing a prioritized list of security vulnerabilities for the computing ecosystem in response to the security vulnerability detection.

### BACKGROUND

Historically, the management of security vulnerabilities has been a complex task due to the vast number of potential threats and the intricate relationships between software applications and detected vulnerabilities. Traditional methods for addressing such challenges involve manual processes and/or rudimentary automated systems that struggle to efficiently prioritize vulnerabilities based on their actual impact on a computing ecosystem. For examples, conventional vulnerability tracking approaches rely on static metrics, such as the severity of vulnerabilities and/or the number of systems impacted, without considering the interconnected nature of modern software applications. This can lead to inefficient security management, where critical vulnerabilities that are more impactful may not be addressed in a timely manner, while less impactful ones receive undue attention. Moreover, the lack of a dynamic and holistic view of the security landscape makes it difficult to adapt to the rapidly evolving nature of threats.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a graph-based vulnerability tracking approach in accordance with some embodiments of the present disclosure.

FIG. 5 depicts a dataflow diagram of an automated vulnerability alerting approach in accordance with some embodiments of the present disclosure.

FIG. 6 depicts a vulnerability dashboard for a graph-based vulnerability tracking approach in accordance with some embodiments of the present disclosure.

FIG. 7 depicts a flowchart diagram of vulnerability tracking process in accordance with some embodiments of the present disclosure.

### DETAILED DESCRIPTION

Various embodiments of the present disclosure provide improved security infrastructure for a computing ecosystem that leverages graph-based data structures and algorithms to detect and remediate security vulnerabilities within the computing ecosystem. The improved security infrastructure leverages a vulnerability graph to track a current state of security vulnerabilities (e.g., via vulnerability nodes) detected within a computing ecosystem and their connection to various the components (e.g., via component edges) within the computing ecosystem. This allows the security infrastructure to update one, comprehensive data structure with vulnerability data as data is received from a set of disparate vulnerability scans. This allows the security infrastructure to leverage graph traversal techniques that detect, prioritize, and address security vulnerabilities to optimize the security of the computer ecosystem in near-real time. In this respect, in some embodiments, the security infrastructure may weigh connections implemented by the vulnerability graph to optimize computer security in view of different security constraints, such as the potential exposure of a software component, the data sensitivity of the software component, and/or the like. These weights may be adapted to any use case to tailor security infrastructure for a particular computing ecosystem. Ultimately, the graph-based data structures and algorithms of the present disclosure allow security infrastructure in any computing ecosystem to continuously track security vulnerabilities within the computing ecosystem and from a set of different vulnerability scans without facing data overload or data backlogs that reduce the efficacy (e.g., in terms of speed) of traditional security infrastructure for large computing ecosystems.

More particularly, some embodiments of the present disclosure present a graph-based vulnerability tracking approach that synthesizes disparate sets of data within a computing ecosystem into a single comprehensive graph-based data structure, referred to herein as a vulnerability graph. By doing so, the graph-based vulnerability tracking approach enables real time queries to a singular data structure to dynamically detect, rank, and prioritize security vulnerabilities within a computing ecosystem. In so doing, some embodiments of the present disclosure improve computer security by efficiently identifying and prioritizing critical security vulnerabilities within a complex computer network environment. For example, to overcome performance deficiencies with traditional vulnerability scanning and prioritization techniques, the methods and systems of the present disclosure leverage graph-based measures, such as centrality measures and/or graph traversal algorithms, to analyze the relationships between software applications and vulnerabilities detected within the ecosystem. This, in turn, enables improving the accuracy and comprehensiveness of high-impact vulnerability detection and streamlines remediation processes, improving overall cybersecurity posture with reduced computational overhead and improved response time.

In some embodiments, the security infrastructure of the present disclosure leverages a vulnerability graph to map a current vulnerability state of a computing ecosystem. The vulnerability graph synthesizes insights from traditionally disparate data sources to model the vulnerability of a computing ecosystem within a single, searchable data structure. By doing so, the vulnerability graph enables real time insights that improve vulnerability detection and mitigation within a computing ecosystem. The vulnerability graph, for example, may connect detected vulnerabilities to impacted software applications within a computing ecosystem that enable real time mitigation actions, such as blocking traffic to/from the impacted software applications, dropping malicious network packet to/from the impacted software applications, among other actions. This, in turn, improves the security of computers within a computing ecosystem and directly addresses technical software maintenance issues in large scale computing ecosystems with diverse software application sets.

In some embodiments, the security infrastructure of the present disclosure leverages prediction mechanisms to rank, prioritize, and filter security vulnerabilities detected within a computing ecosystem based on a predicted impact of a vulnerability on the computing ecosystem as a whole. For instance, the prediction mechanism may synthesize graph-based measurements across a vulnerability graph to prioritize vulnerabilities based on their holistic impact on an ecosystem. By doing so, the prediction mechanism may replace traditionally resource intensive and/or static prediction protocols with a faster and more comprehensive prediction approach that may be used in near real time to continuously provide vulnerability insights for mitigation. This, in turn, enables faster, and more targeted, remediation actions, such as the blocking of traffic to/from impacted software applications, dropping of malicious network packets to/from impacted software applications, among other actions, to improve the security of a computing ecosystem.

Examples of technologically advantageous embodiments of the present disclosure comprise improved computer security techniques, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

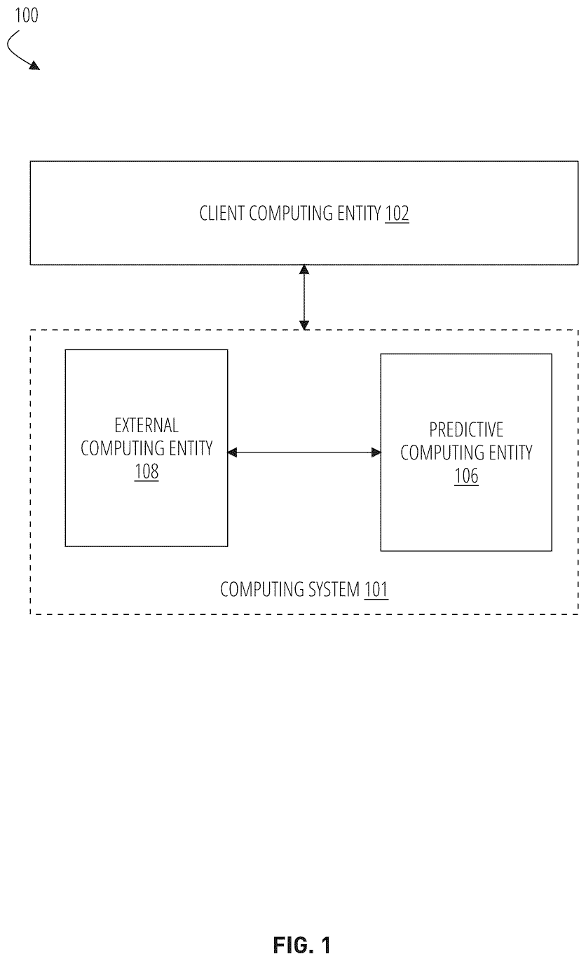

FIG. 1 depicts a block diagram of an example architecture 100 in accordance with some embodiments of the present disclosure. The architecture 100 comprises a computing system 101 configured to receive a request, such as a security vulnerability detection, and/or the like, from client computing entities 102, process the request, and provide the prioritized security vulnerabilities to the client computing entities 102. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., vulnerability tracking) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as scanning results, application data, ownership data, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

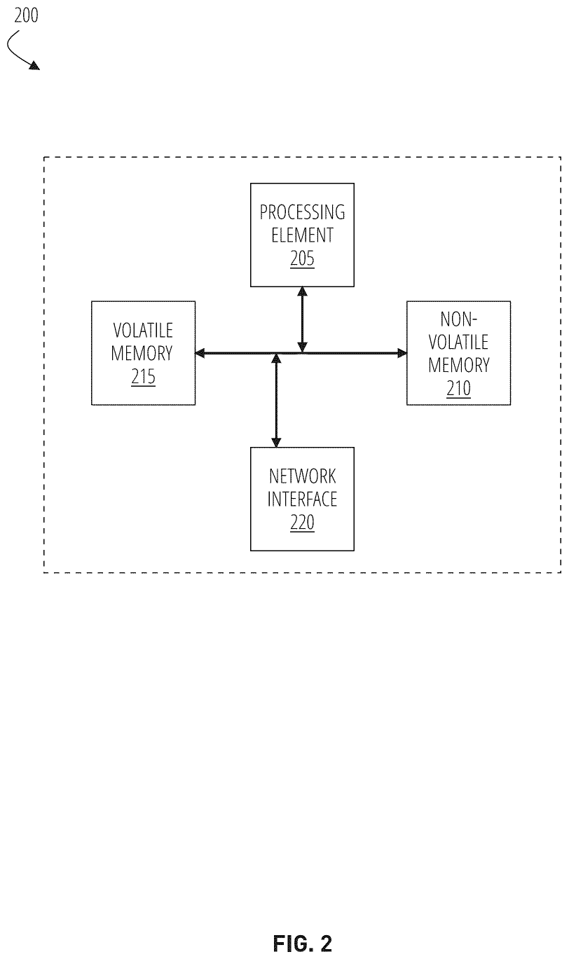

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

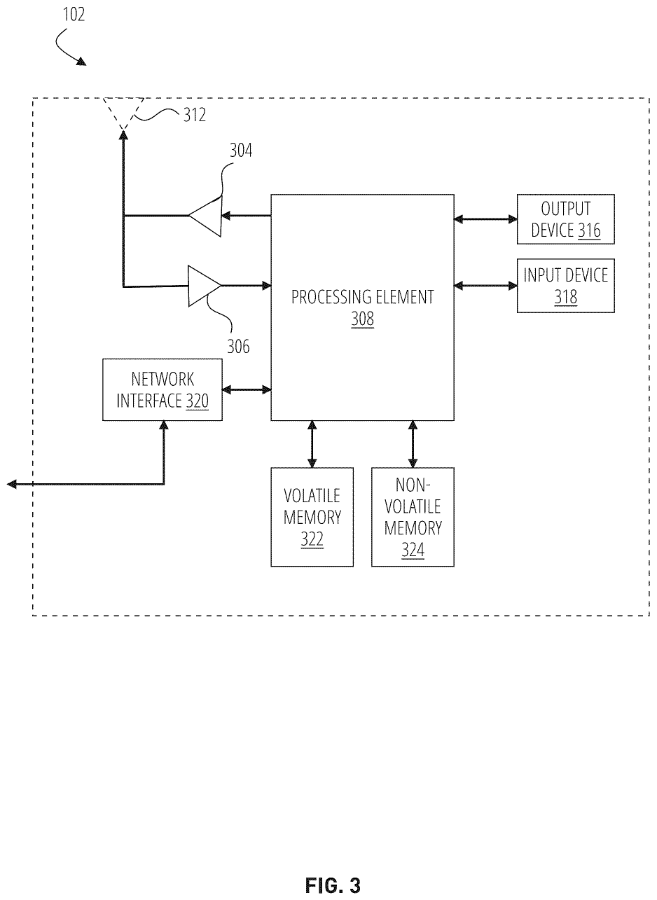

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer security. In particular, systems and methods are disclosed herein that adapt graph-based technologies to a computer security domain. By doing so, the graph-based techniques of the present disclosure enable improved security vulnerability detection and remediation processes that, when executed on a computer, improves computer security, This, in turn, may improve the functionality of a computer with respect to various computing tasks, including data security, software application maintenance, network communication, and the like.

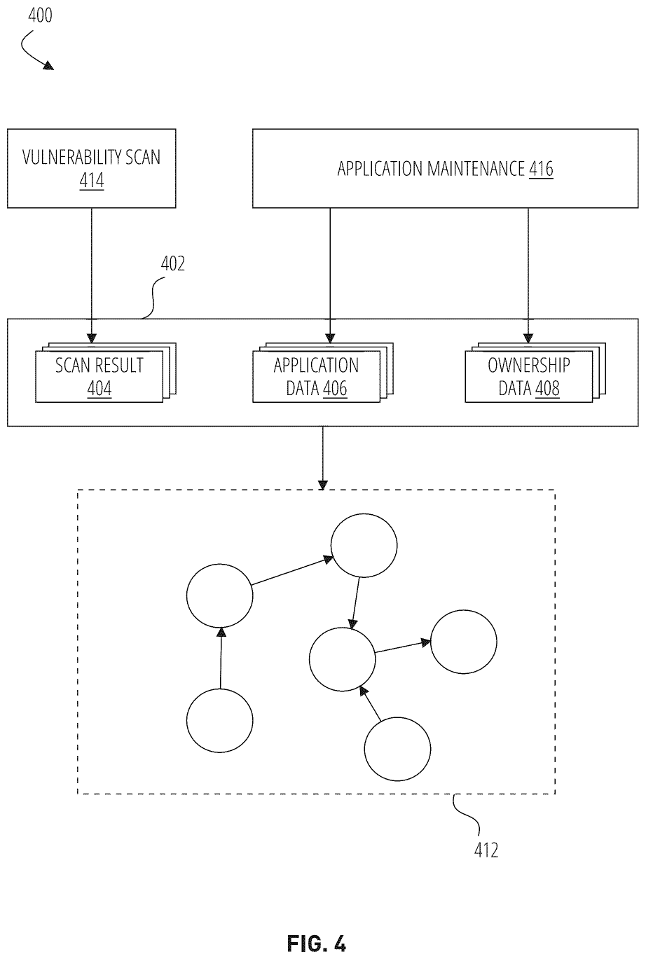

FIG. 4 depicts a dataflow diagram 400 of a graph-based vulnerability tracking approach in accordance with some embodiments of the present disclosure. The dataflow diagram 400 comprises a graph generation and modification process configured to dynamically synthesize disparate sets of data into a comprehensive and queryable graph data structure, i.e., a vulnerability graph 412, reflective of a current vulnerability state within a computing ecosystem 402. As described herein, the disparate sets of data may be automatically logged, recorded, and/or otherwise accessed by security infrastructure within a computing ecosystem 402, such as the computing system 101 of the present disclosure, to detect, track, and remediate security vulnerabilities within the computing ecosystem 402 over time. To improve timing, comprehensiveness, and prioritization of remedial actions, the computing system 101 may map the disparate sets of data into a single vulnerability graph that indicates vulnerabilities within a computing ecosystem as well as the potential impacts of the vulnerabilities to software applications and users of the computing ecosystem 402. This enables near real time vulnerability ranking, remediation, and proactive security measures to prevent network intrusions (and/or other malicious activities) within the computing ecosystem 402.

In some embodiments, a computing ecosystem 402 is a computing environment with security management infrastructure for detecting, managing, and mitigating security vulnerabilities of a set of networks computers. A computing ecosystem 402, for example, may comprise a set of computing devices (e.g., endpoint computing devices, servers, peering devices), software applications and/or operating containers (e.g., virtual machines, containers), user accounts and/or roles (e.g., permissions, access policies), and/or the like that are interconnected and managed as a unified system. The security management infrastructure is designed to facilitate efficient operation and security management across the enterprise through application maintenance 416 and vulnerability scans 414. In some embodiments, the computing ecosystem 402 comprises network infrastructure, security protocols, centralized management tools, and/or the like to implement the vulnerability scans 414 and/or application maintenance 416 processes. For example, the network infrastructure may utilize various technologies, such as local area networks (“LANs”), wide area networks (“WANs”), and virtual private networks (“VPNs”), and/or the like, to connect the set of computers within a centralized ecosystem. Within the centralized ecosystem, security protocols and centralized management tools, such as firewalls, intrusion detection systems, encryption mechanisms, and/or the like, may be implemented to protect a set of computers and/or the users thereof from network attacks and/or other threats.

A computing ecosystem 402 may comprise a combination of hardware and software components. The hardware components, for example, may comprise a set of personal computers, servers, workstations, networking equipment, and/or the like. The software components may comprise operating systems, applications, management tools, and/or the like. Both hardware and software components are susceptible to security vulnerabilities that, in some cases, may be introduced through the installation, access, and/or use of a software application within the computing ecosystem 402. To manage such vulnerabilities, a computing system 101 of the computing ecosystem 402 may monitor various aspects of the computing ecosystem 402 to generate scan results 404 (e.g., through vulnerability scans 414), application data 406 (e.g., through application maintenance 416), and/or ownership data 408 (e.g., through application maintenance 416). In some examples, the vulnerability scan may comprise detecting one or more hardware and/or software components associated with a common vulnerabilities and exposures (CVE) score. This may be at least part of detecting a vulnerability.

For example, the application maintenance 416 may comprise one or more software application onboarding, review, and/or management operations. In some examples, during the software application onboarding and/or review operations, application data 406 may be generated, stored, and/or accessed for up to each of a set of software applications onboarded (e.g., installed, approved for access) within the computing ecosystem 402. The application data 406 for a particular software application may comprise software application information that may identify one or more of a type of data handled by the application (e.g., PHI, PII, non-PHI, non-PII, publicly accessible, proprietary, trade secret), a sensitivity level of the type of data, an exposure level of the application (e.g., internal facing only, public web application, hosted within corporate firewall, cloud application), a data flow between the application and one or more affiliated applications, and/or the like. In some examples, the application data 406 may be stored in association with a unique component identifier that corresponds to the particular software application.

In some examples, during the software application onboarding, review, and/or management operations, ownership data 408 may be generated, stored, and/or accessed for up to each of a set of software applications accessible within the computing ecosystem 402. The ownership data 408 may comprise enterprise organizational information, such as software application ownership information, management reporting structure, financial information, and/or the like. By way of example, the ownership data 408 may identify one or more of a current, past, and/or future application technical owner, application service-level owner, application business owner, one or more reporting chains, and/or the like. In some examples, the ownership data 408 may be stored in association with a unique component identifier that corresponds to the particular software application.

In some embodiments, the computing ecosystem 402 provides a controlled and secure environment for enterprise computing activities that leverage a set of software applications respectively corresponding to unique component identifiers. The unique component identifiers enable performance and vulnerability tracking with respect to up to each of the software application. This allows a computing system 101 to manage user access, deploy and update software, monitor system performance, and/or ensure data security across a set of software applications. For example, to maintain security within the computing ecosystem 402, the computing system 101 may perform at least one vulnerability scan 414 to monitor and proactively address network vulnerabilities that may be used by adverse parties to harm the computing ecosystem 402.

In some embodiments, a vulnerability scan 414 is one of a series of vulnerability scanning tools (e.g., cloud vulnerability scanning, app scanning, database scanning, network scanning, authenticated scanning, host-based scanning) that is configured to generate a scan result 404 that identifies one or more software security vulnerabilities within the computing ecosystem 402 and/or one or more software applications therein. Up to each of the security vulnerabilities may comprise a corresponding unique vulnerability identifier and/or one or more unique component identifiers that identify software applications impacted by the security vulnerability.

A vulnerability scan 414 may be performed using one or more different security tools (e.g., commercially available, customized home-grown) to generate a set of scan results 404 that blend security vulnerability insights from a plurality of different analytic approaches. For example, up to each of the different vulnerability scans 414 may comprise a different systematic process of probing computer systems, networks, and/or software applications within the computing ecosystem 402 to identify security weaknesses or misconfigurations. A vulnerability scan 414 may comprise one or more network protocols, security analysis algorithms, automated testing methodologies, and/or the like. In some examples, a vulnerability scan 414 may use one or a combination of techniques, including port scanning, version checking, known vulnerability matching, fuzzing or dynamic analysis for application-level vulnerabilities, and/or the like to identify security vulnerability.

A vulnerability scan 414 may be configured to proactively identify security weaknesses in a computing ecosystem 402 before exploitation by malicious actors. To do so, a vulnerability scan 414 may generate detailed reports (e.g., scan result 404) of discovered vulnerabilities that may comprise information, such as vulnerability descriptions, impacted software applications, potential remediation steps, and/or the like. In some examples, a scan result 404, for example, may comprise a record and/or data structure that contains detailed information about one or more security vulnerabilities detected during a vulnerability scan 414 of the computing ecosystem 402. A scan result 404 may comprise various data points for a detected security vulnerability, such as a unique vulnerability identifier, impacted software application identifiers, vulnerability descriptions, potentially severity ratings, remediation suggestions, and/or the like.

At any given time, a computing ecosystem 402 may be associated with a set of vulnerabilities that are detected across the series of vulnerability scanning tools. Traditionally, the scan results 404 reflective of these security vulnerabilities are stored within disparate records that are unaffiliated with the application data 406 and ownership data 408 recorded for a set of software applications within the computing ecosystem 402. By doing so, security infrastructure within a computing ecosystem 402 fails to holistically address security vulnerabilities across a set of software applications. This leads to low vulnerability response times and ineffective responses that reduce the security within computing ecosystem 402.

In some embodiments, the security vulnerabilities within a computing ecosystem 402 are mapped within a vulnerability graph 412. The vulnerability graph 412 may define one or more of a set of component nodes, a set of vulnerability nodes, and/or a set of graph edges that respectively connect sets of related nodes within the vulnerability graph 412. The set of graph edges, for example, may comprise an application-application edge that connects two component nodes of the set of component nodes, an application-vulnerability edge that connects a component node to a vulnerability node 506, and/or a vulnerability-vulnerability edge that connects two vulnerability nodes of the set of vulnerability nodes.

In some embodiments, the vulnerability graph 412 is a graph data structure that maps security vulnerabilities to software applications within a computing ecosystem 402. A vulnerability graph 412 is a specialized representation that visually and logically connects detected security vulnerabilities with the software applications they potentially impact. In some examples, the vulnerability graph 412 comprises a superset of nodes representing software applications and vulnerabilities, connected by edges that signify relationships between them. This structure allows for efficient traversal and analysis of the relationships between potential security vulnerabilities and software applications accessed within a computing ecosystem 402. A vulnerability graph 412 may be stored, manipulated, queried, and/or otherwise accessed within a graph database and/or specialized graph data structures in memory. In addition, or alternatively, custom data structures may be used to store the vulnerability graph 412, such as adjacency lists, matrices, and/or the like.

In some embodiments, the vulnerability graph 412 is generated by mapping scan results 404, application data 406, and/or ownership data 408 into a graph data structure. For example, the scan results 404 may be mapped to a set of vulnerabilities nodes, the application data 406 may be mapped to a set of component nodes, and the ownership data 408 may be mapped to attributes of the set of component nodes (and/or one or more connected owner nodes). As described herein, a vulnerability graph 412 may be initially constructed and/or continuously updated based on the results of application maintenance 416 and/or vulnerability scans 414. By way of example, one or more new component nodes may be generated in response to one or more software application onboarding operations, one or more existing component nodes may be updated in response to application management operations, one or more new vulnerability nodes may be generated in response to vulnerability scan 414, and/or the like. In this manner, the vulnerability graph 412 may serve as a queryable intermediary between a computing system 101 and enterprise data for a computing ecosystem 402. This may enable the use of the vulnerability graph 412 for the near real time detection, prioritization, and management of security vulnerabilities within the computing ecosystem 402, as described herein.

More particularly, a vulnerability node may comprise one node type within a vulnerability graph 412 that represents a security vulnerability detected by a vulnerability scan 414 (and/or manually observed). A vulnerability node, for example, may comprise vulnerability information for a particular security vulnerability, such as an enterprise-level unique vulnerability identifier, a vulnerability description, a corresponding scan result identifier, and/or the like. In some examples, this information is derived from a scan result 404 and stored as attributes within a vulnerability node. A vulnerability node may represent a specific security weakness and/or exposure within the computing ecosystem 402. By connecting vulnerability nodes to component nodes via edges in the vulnerability graph 412, the vulnerability graph 412 may represent software applications that may be impacted by a particular vulnerability and vice versa. This allows for efficient tracking and management of security issues across the computing ecosystem 402.

In some examples, vulnerability nodes may be assessed, using one or more techniques of the present disclosure, to implement one or more computer security operations. For example, a set of vulnerability nodes may be assessed to determine a severity and/or exposure of a vulnerability within a computing ecosystem 402 in near real time. In addition, or alternatively, the set of vulnerability nodes may serve as key reference points for tracking the lifecycle of security issues, from detection through to resolution. In some examples, up to each of the set of vulnerability nodes may comprise attributes, such as severity scores, exploit potential, remediation status, temporal attributes, and/or the like. These may provide more context for security analysis and/or decision-making that may allow for tracking of vulnerability persistence over time and facilitating trend analysis.

In some embodiments, a component node comprises another node type within a vulnerability graph 412 that represents a software application accessible within a computing ecosystem 402. A component node may represent a specific software application and its associated attributes. For example, a component node may comprise an enterprise-level unique component identifier, a risk weight, ownership information, and/or the like for a particular software application. In some examples, a component node may serve as a point of reference for security analysis within the vulnerability graph 412 that allows a computing system 101 to detect and/or assess the risk profile of individual software applications within the computing ecosystem 402 in near real time. In some examples, the unique component identifier may ensure that up to each component node is unambiguously referenced. In addition, or alternatively, a component node may comprise a risk weight that is based on a data access privilege of a software application corresponding to the component node and/or an owner attribute for identifying and/or notifying one or more responsible parties, in near real time, when security issues are detected.

In some embodiments, a risk weight comprises an attribute of a component node that describes a sensitivity level of a software application. A risk weight, for example, may provide a quantitative measure of the application's sensitivity and/or potential impact if compromised. In some examples, a risk weight may comprise a numerical and/or categorical value that quantifies the potential impact or risk associated with a particular software application within the computing ecosystem 402. The risk weight may be assigned based on one or more security factors, such as a sensitivity level of data handled by the software application (e.g., personally identifiable information, financial data), a software application's exposure level (e.g., internal-facing only, public-facing), and/or the like. By way of example, a software application's exposure level may be based on a deployment type (e.g., internal access only, network access by external parties, downloadable by external parties), permission range (e.g., all user accounts may access, administrator only, subset of user account may access), deployment location (e.g., public cloud, on-prem, edge node), and/or the like.

In some examples, a risk weight may be represented as a numerical value (e.g., normalized to a specific range, such as 0 to 1 or 1 to 100), or as a categorical value (e.g., low, medium, high). This value would be stored as an attribute of the component node in the vulnerability graph 412. A risk weight may be leveraged as a quantitative and/or qualitative measure of a software application's importance from a security perspective. This allows for more nuanced prioritization of security efforts and resource allocation. For example, in vulnerability analysis, edges connected to component nodes with higher risk weights might be given more importance, influencing the overall risk assessment.

In some embodiments, a computing system 101 initiates one or more vulnerability scans 414 for the computing ecosystem. For example, the computing system 101 may initiate one or more vulnerability scans 414 at a scanning frequency. As described herein, the vulnerability scan 414 may output a scan result 404 that comprises a unique vulnerability identifier, a unique component identifier, a vulnerability description, and/or one or more attributes that describe a security vulnerability. The scan result 404 of a vulnerability scan 414 may provide a detailed snapshot of a current security state of the computing ecosystem 402. In some examples, the computing system 101 may leverage scan results 404, performed at a scanning frequency, as primary input for updating the vulnerability graph 412 to accurately represent a current vulnerability of the computing ecosystem 402.

In some embodiments, a scanning frequency is an interval (e.g., an hour, day, week, month) at which a vulnerability scan 414 is performed. In some examples, a scanning frequency may be preset and/or dynamically set using a scheduling algorithm, resource management interface, and risk assessment methodologies, and/or the like to periodically scan a computing ecosystem 402 for one or more vulnerabilities. In some examples, the scanning frequency may be set by balancing the need for up-to-date security information with the computational and network resources required to perform scans. In addition, or alternatively, a scanning frequency may be based on a criticality of the systems being scanned, a rate of change in the computing ecosystem 402, regulatory requirements, and/or the like. In some examples, the balancing may be performed using one or more automated scheduling systems, such as a Task Scheduler, and/or the like. In some examples, enterprise job scheduling software may be implemented to distribute scanning tasks across multiple systems and/or adjust schedules based on system load or other factors. By way of example, the scheduling software may perform adaptive scheduling, where the scanning frequency is automatically adjusted based on factors, such as the historical rate of vulnerability discovery, current threat intelligence, and/or the like. In addition, or alternatively, the scanning frequency may comprise differential scanning, where different parts of the computing ecosystem 402 may be scanned at different frequencies based on their risk profile, importance, and/or the like.

In some embodiments, a computing system 101 modifies the vulnerability graph 412 based on one or more scan results 404 from the one or more vulnerability scans 414. For example, the computing system 101 may determine a particular vulnerability node for the security vulnerability based on the unique vulnerability identifier. For example, the computing system 101 may query the vulnerability graph 412 for a node that comprises the unique vulnerability identifier. In the event of a null query response, the computing system 101 may generate a new vulnerability node and assign the unique vulnerability identifier to the new vulnerability node. The computing system 101 may update a subset of the set of graph edges that connects to the particular vulnerability node (e.g., an existing or new node) based on the unique component identifier to logically connect the particular vulnerability node to each software application impacted by the vulnerability.

A graph edge, for example, may defined a relationship between entities within the vulnerability graph 412. For instance, graph edges may comprise the connective elements that link nodes in the vulnerability graph 412, representing various types of relationships between software applications and/or vulnerabilities within the computing ecosystem 402. An edge may represent different types of relationships, such as data flow between software applications, an impact of a security vulnerability on a software application, and/or the like. By way of example, an edge may comprise a vulnerability-application edge that defines an impact of a vulnerability on a connected software application.

In some embodiments, a graph edge establishes a relationship between different entities in the vulnerability graph 412 to enable an identification of influence within the vulnerability graph 412. For example, an edge connecting a vulnerability node to a component node indicates that the specific vulnerability impacts (e.g., influences) that software application. In some examples, edges may carry contextual attributes, such as the severity of the impact, the nature of the data flow between software applications, and/or the like. As described herein, using the graph edges of the vulnerability graph 412, a computing system 101 may traverse the vulnerability graph 412 to holistically detect and prioritize vulnerabilities across a set of software applications within a computing ecosystem 402. By continuously updating the vulnerability graph to track a current state of the computing ecosystem 402, the vulnerability graph 412 may enable a computing system 101 to traverse the vulnerability graph 412 to detect and mitigate security vulnerabilities across up to each of a set of impacted software applications mapped to the security vulnerability within the vulnerability graph 412.

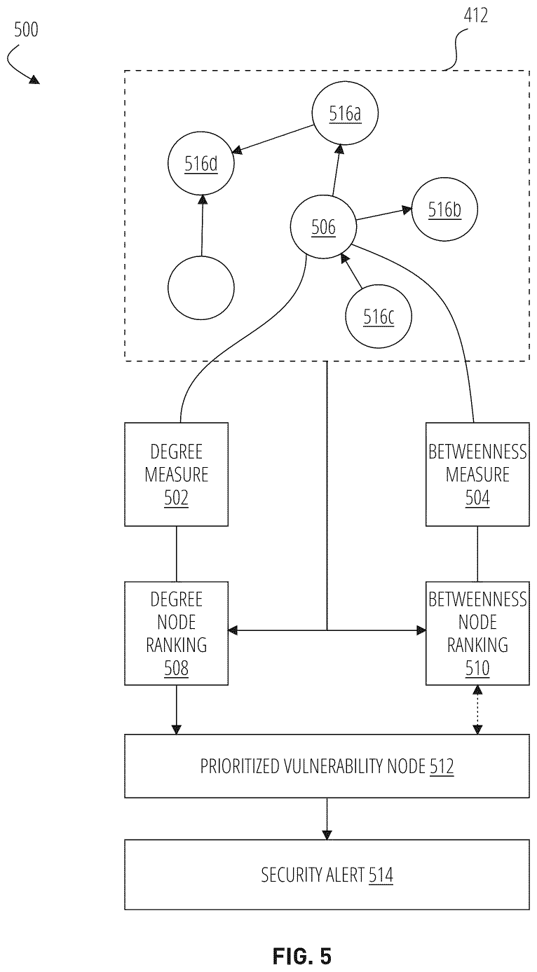

FIG. 5 depicts a dataflow diagram 500 of a graph-based vulnerability tracking approach in accordance with some embodiments of the present disclosure. The graph-based vulnerability tracking approach builds upon a vulnerability graph to dynamically track, prioritize, and remediate security vulnerabilities within a computing ecosystem in near real time. For example, the graph-based vulnerability tracking approach may be implemented by security infrastructure within the computing ecosystem, such as the computing system 101 of the present disclosure, to continuously detect and monitor vulnerabilities within a computing ecosystem. To do so, the computing system 101 may synthesize one or more graph-based measures, such as a degree measure 502 and/or a betweenness measure 504, to detect a severity of a vulnerability based on characteristics expressed within the graph. This, in turn, enables the computing system 101 to make holistic prioritizations, in near real time, that accurately account for the severity of a vulnerability across a complex set of software applications within a computing ecosystem. In this manner, the computing system 101 may rank and remediate vulnerabilities and/or proactively trigger security measures within the computing ecosystem in near real time to defend the computing ecosystem from network intrusions (and/or other malicious activities).

In some embodiments, the computing system 101 receives a security vulnerability detection for a computing ecosystem. In some embodiments, the security vulnerability detection is a trigger for determining a prioritized vulnerability for a computing ecosystem. The stimulus may initiate the vulnerability assessment of a current state of the computing ecosystem 402, as represented by the vulnerability graph 412, to detect and mitigate security vulnerabilities within the computing ecosystem. A security vulnerability detection may comprise an event-driven trigger, scheduled trigger, manual trigger, and/or the like. By way of examples, the stimulus may be initiated through various mechanisms, including automated scheduling systems, user-initiated queries, and/or the like, that are designed to prompt a reevaluation of the ecosystem's security priorities.

More particularly, a security vulnerability detection may comprise an automated, interval-based stimuli, such as a job scheduling system, which may trigger analysis processes at predefined intervals. In addition, or alternatively, a security vulnerability detection may comprise a user-initiated stimuli, such as an API endpoint and/a user interface component that allows security personnel to manually initiate the prioritization process. In some examples, the security vulnerability detection may comprise an event-based trigger that is initiated in response to an event, such as the completion of a scan result, an onboarding of a software application, and/or the like.

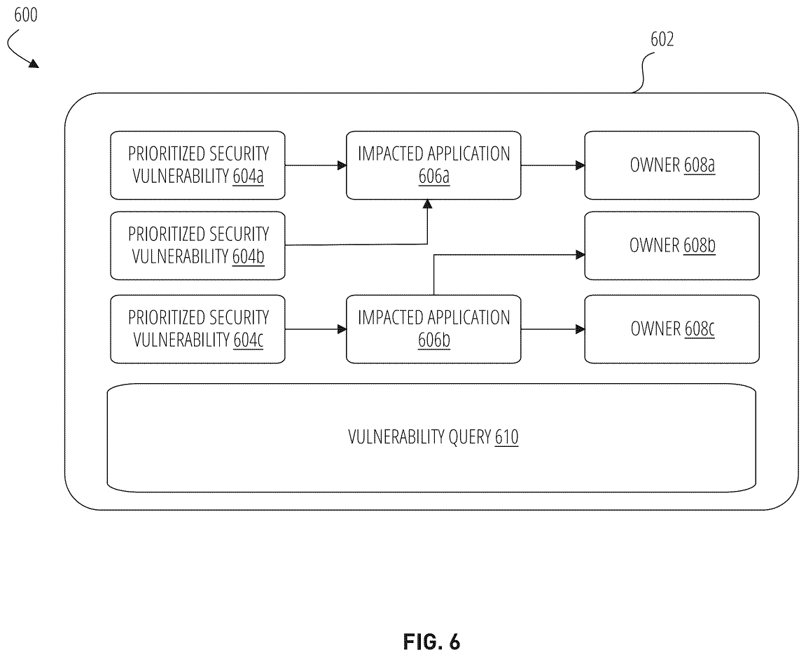

In response to a security vulnerability detection, a computing system 101 may initiate a vulnerability detection service configured to detect and prioritize the vulnerabilities within a current state of a computing ecosystem 402. By triggering regular reassessments, a security vulnerability detection may prompt the computing system 101 to maintain an up-to-date view of the critical security issues in the computing ecosystem. This is particularly important in dynamic environments where new vulnerabilities may be discovered, or the relative importance of different software applications may change over time. In some examples, security vulnerability detection triggers a full recalculation of vulnerability priorities across the entire ecosystem. In addition, or alternatively, the security vulnerability detection may initiate one or more targeted analyses focused on specific subsets of software applications and/or vulnerability types. In some examples, the results of these analyses may be used to update dashboards (e.g., the vulnerability dashboard 600 of FIG. 6), generate alerts, and/or initiate automated remediation processes.

In some embodiments, the computing system 101 determines the vulnerability graph 412 for the computing ecosystem. For example, the computing system 101 may identify the vulnerability graph 412 from one or a plurality or vulnerability graphs respectively corresponding to one or a plurality of computing ecosystems. By way of example, the security vulnerability detection may comprise an ecosystem identifier that identifies the computing ecosystem from a plurality of computing ecosystems.

In some embodiments, the computing system 101 determines a degree measure 502 and/or a betweenness measure 504 for a vulnerability node 506 of the plurality of vulnerability nodes within the vulnerability graph 412. For example, the computing system 101 may determine the degree measure 502 and/or betweenness measure 504 in response to the security vulnerability detection. In some examples, computing system 101 may determine the degree measure 502 and/or betweenness measure 504 for up to each of the set of vulnerabilities nodes within the vulnerability graph 412. In some examples, the computing system 101 may determine the degree measure 502 and/or betweenness measure 504 for a subset of vulnerability nodes identified by a security vulnerability detection.

In some embodiments, the degree measure 502 for the vulnerability node 506 is a degree centrality measure that is determined based on a number of incoming and/or outgoing edges of the vulnerability node 506. In some examples, the degree measure 502 may be weighted based on the sensitivity of software applications connected to the vulnerability node 506. For example, the computing system 101 may determine a set of weighted edge measurements for the vulnerability node 506. In some examples, the set of weighted edge measurements may comprise a respective weight edge measurement for up to each of a subset of the set of graph edges connected to the vulnerability node 506. For example, weighted edge measurement of the set of weighted edge measurements may correspond to an edge that connects the vulnerability node 506 to a component node and the weighted edge measurement may be based on a risk weight of the connected component node. In some examples, the computing system 101 may generate the degree measure 502 by aggregating the set of weighted edge measurements for the vulnerability node 506.

More particularly, the degree measure 502 may be a degree centrality measurement for a particular node that is based on a set of weighted edge measurements. The degree measure 502, for example, may quantify the importance and/or influence of a node within the vulnerability graph 412 based on its connections to other nodes. By way of example, the degree measure 502 for the vulnerability node 506 may be determined by considering the number of edges of the vulnerability node 506 and/or the weights of up to each of the edges. These weights may be derived from the risk weights of the connected component nodes, reflecting the sensitivity and/or potential impact of the software applications if compromised. In this manner, the degree measure 502 may identify security vulnerabilities with the most connections, adjusted by weight, which have the highest impact on a computing ecosystem.

By way of example, the degree measure 502 may be determined by traversing the vulnerability graph 412 according to the following pseudocode:
let D be a dictionary
for all nodes n in graph G
   n_{d}=number of incoming edges from a software application connected to n*sensitivity of the software application+number of outgoing edges from a software application connected to n*risk weight.
   D.add(n, n_{d})

In some embodiments, the weighted edge measurement is a scaled edge that is scaled based on the risk weight of a connected software application and represents an importance of a connection between a vulnerability node and a component node in a vulnerability graph 412. The weighted edge measurement may be derived from attributes of the connected nodes. For example, a weighted edge may comprise a risk weight of the component node in a vulnerability-component node pair connected by the weighted edge. In this way, the weighted edge measurement may reflect factors, such as the sensitivity of data handled by the software application and/or its level of external exposure. This allows for more nuanced representation of the relationships between vulnerabilities and software applications in the computing ecosystem. For example, by incorporating the risk weight of software applications into the edge weights, the vulnerability graph 412 may more accurately reflect the potential impact and/or risk associated with each vulnerability-application connection; thereby allowing for more sophisticated analysis and prioritization of security issues in near real time.

In some embodiments, the betweenness measure 504 for the vulnerability node 506 is a betweenness centrality measure that is determined based on a number of shortest paths that traverse the vulnerability node 506. For example, the computing system 101 may determine a set of shortest paths within the vulnerability graph 412. The computing system 101 may determine a subset of the set of shortest paths that comprise the vulnerability node 506 and determine the betweenness measure 504 for the vulnerability node 506 by dividing a first number of the subset of shortest paths that comprise the vulnerability node by a second number of the set of shortest paths between node pairs of all nodes, with or without the vulnerability node in the path.

More particularly, the betweenness measure 504 may quantify the importance of a node in terms of its role in connecting different parts of the graph. The betweenness measure 504, for example, may be determined by identifying all shortest paths between pairs of nodes in the graph, then determining how many of these paths pass through each node. By doing so, the betweenness measure 504 may identify nodes that act as bridges and/or bottlenecks within the vulnerability graph 412. In the context of cybersecurity, vulnerabilities with high betweenness measures 504 may represent critical points of failure and/or compromise that have potentially far-reaching effects across the computing ecosystem. In this way, the betweenness measure 504 may provide a different perspective on vulnerability importance compared to the degree measure 502, focusing on the node's role in information flow rather than its direct connections.

By way of example, the betweenness measure 504 may be determined using the following equation:

$$g ( v ) = {\sum }_{s \neq v \neq t} \frac{{σ}_{st} ( v )}{{σ}_{st}}$$

In some embodiments, the computing system 101 determines a set of prioritized vulnerability nodes 512 from the vulnerability graph 412 based on the degree measure 502 and/or the betweenness measure 504. For example, the computing system 101 may generate (a) a degree node ranking 508 from the vulnerability graph 412 based on the degree measure 502 and (b) a betweenness node ranking 510 from the vulnerability graph based on the betweenness measure 504. The computing system 101 may determine the set of prioritized vulnerability nodes 512 based on the degree node ranking 508 and/or the betweenness node ranking 510.

In some embodiments, the degree node ranking 508 is a ranked list of nodes that are ranked according to a degree measure 502 for up to each of the set of vulnerability nodes within the vulnerability graph 412. For example, the computing system 101 may determine a degree measure 502 for up to each of the set of vulnerability nodes and sort up to each of the set of vulnerability nodes based on their respective degree measures 502. In this way, the degree node ranking 508 may provide a prioritized list of nodes based on their connectivity and influence within the vulnerability graph 412.

In some embodiments, the betweenness node ranking 510 is a ranked list of nodes that are ranked according to betweenness measure 504 for up to each of the set of vulnerability nodes within the vulnerability graph 412. For example, the computing system 101 may determine a betweenness measure 504 for up to each of the set of vulnerability nodes and sort up to each of the set of vulnerability nodes based on their respective betweenness measures 504. In this way, the betweenness node ranking 510 may provide a prioritized list of nodes based on their importance as intermediaries and/or bridges within the vulnerability graph 412.

In some embodiments, the computing system 101 determines the set of prioritized vulnerability nodes 512 from the vulnerability graph 412 based on a first position of up to each of set of the prioritized vulnerability nodes 512 within the degree node ranking 508. In addition, or alternatively, the computing system 101 may verify the set of prioritized vulnerability nodes 512 based on a second position of up to each of set of the prioritized vulnerability nodes 512 within the betweenness node ranking 510. By way of example, a prioritized vulnerability node of the set of prioritized vulnerability nodes 512 may comprise a node ranked within a top percentile of the degree node ranking 508 that may be verified as a prioritized vulnerability node if the node is ranked within a threshold ranking (e.g., top 5%, top 10, 95th percentile) of the betweenness node ranking 510.

In some embodiments, a prioritized vulnerability node of the set of prioritized vulnerability nodes 512 is a vulnerability node 506 that is selected from at least one of the degree node ranking 508 and/or the betweenness node ranking 510. For example, the prioritized vulnerability node may comprise the highest ranked vulnerability node within the degree node ranking 508 that is also within a top percentile of the betweenness node ranking 510 and/or vice versa. In this way, the computing system 101 may cross check a vulnerability node 506 across multiple measures of centrality within the vulnerability graph 412 to detect a security vulnerability within a computing ecosystem.

In some embodiments, the computing system 101 implements a prediction mechanism that leverages the degree node ranking 508 and/or betweenness node ranking 510 to select the set of prioritized vulnerability nodes 512 from the vulnerability graph 412. The prediction mechanism, for example, may synthesize the degree node ranking 508 with the betweenness node ranking 510 to detect a set of prioritized vulnerability nodes 512 that is highest with respect to both rankings. In addition, or alternatively, the prediction mechanism may generate a synthesized ranking that ranks up to each of the set of vulnerability nodes based on a synthesized measure for up to each of the set of vulnerability nodes. The synthesized measure, for example, may comprise an aggregate score that combines (e.g., averages, adds) a position of a vulnerability node 506 in up to each of the rankings and/or combines a measure (e.g., degree measure 502, betweenness measure 504) of a vulnerability node 506 in up to each of the rankings.

In some embodiments, the computing system 101 provides a prioritized list of security vulnerabilities for the computing ecosystem in response to the security vulnerability detection. In some examples, the computing system 101 may automatically initiate a vulnerability resolution action for the prioritized list of security vulnerabilities.

In some embodiments, the prioritized list of security vulnerabilities is a set of security vulnerabilities that respectively correspond to the set of prioritized vulnerability node 512 and are shortlisted for remediation of specific security weaknesses and/or exposures within the computing ecosystem that have been identified as particularly critical and/or important based on graph analysis and other relevant factors. In some examples, the prioritized list of security vulnerabilities may be represented as a data structure and/or object comprising one or more attributes, such as a unique vulnerability identifier, a vulnerability description, impacted software applications, and prioritization scores, and/or the like. The attributes, for example, may be queried from a corresponding vulnerability node 506. The prioritized list of security vulnerabilities may enable a computing system 101 to focus remediation efforts on the most critical security issues within a computing ecosystem. By identifying specific vulnerabilities as high priority, security teams may allocate their resources more effectively, addressing the vulnerabilities that pose the greatest risk to the organization first. This helps to maximize the impact of security efforts and reduce overall risk in the most efficient manner possible. For examples, prioritized security vulnerabilities may drive various security processes and/or actions, such as by triggering automated alerts to relevant owners, initiating remediation workflows, and/or by prominently featuring a security risk in a security reports and/or dashboard (such as the vulnerability dashboard 600 of FIG. 6).

In some embodiments, the computing system 101 determines a subset of impacted component nodes 516a-c from the set of component nodes based on a subset of the set of graph edges that respectively connect the set of prioritized vulnerability nodes 512 to the subset of impacted component nodes 516a-c. For example, the computing system 101 may traverse, via a breadth-first (or depth-first) graph search from the set of prioritized vulnerability nodes 512, an initial subset of impacted component nodes 516a-d from the set of component nodes. In some examples, the computing system 101 may remove at least one impacted component node (e.g., 516d) from the initial subset of impacted component nodes 516a-d based on a comparison between a risk weight of the at least one impacted component node (e.g., 516d) and a risk threshold.

In some embodiments, an impacted component node 516a-d is a component node that is directly (e.g., 516a-c) and/or indirectly (516d) connected to a vulnerability node 506 selected as one of a set of prioritized vulnerability node 512. In this way, the impacted component nodes 516a-d may represent software applications within the computing ecosystem that are potentially affected by a high-priority security vulnerability. In some examples, the computing system 101 may determine the impacted component nodes 516a-d using graph traversal algorithms, connectivity analysis, and/or data structures for representing complex relationships. For example, the computing system 101 may identify impacted component nodes 516a-d through graph traversal algorithms, such as breadth-first search, depth-first search, and/or the like. By doing so, the computing system 101 may identify a potential scope and/or impact of a prioritized vulnerability in near real time. For example, by mapping out which software applications are affected, the computing system 101 may better assess the overall risk posed by the vulnerability and initiate remediation efforts accordingly. For instance, the impacted component nodes 516a-d may be used to generate reports detailing the impacted systems, to notify application owners about relevant vulnerabilities, track the progress of remediation efforts across multiple impacted software applications, and/or the like. In some cases, the set of impacted component nodes 516a-d might also be used to identify common vulnerabilities affecting multiple software applications, to reveal systemic issues in the computing ecosystem.

In some embodiments, the impacted component nodes 516a-c are pruned based on a risk level associated with a set of initial impacted component nodes 516a-d. For instance, the 516a-c may be pruned by removing component nodes that do not meet or exceed a risk threshold. A risk threshold, for example, may describe a level of exposure for prioritizing a software application for remediation. The risk threshold, for example, may represent a cutoff point that determines whether a software application's level of exposure, as identified by a corresponding risk weight, is significant enough to warrant prioritized attention and/or remediation efforts. By way of example, a risk threshold may comprise a static measure (e.g., 0.5 risk weight) and/or a relative measure (e.g., an average risk weight of a set of impacted component nodes 516a-d) that is relative to a set of impacted component nodes 516a-d.

In some embodiments, the computing system 101 may determine a set of owners for the prioritized list of security vulnerabilities based on the owner attributes of up to each of the impacted component nodes 516a-c. The computing system 101 may provide a near real time security alert 514 that identifies a prioritized security vulnerability of the list of security vulnerabilities and a component corresponding to up to each of the impacted component nodes 516a-c to at least one owner of the set of owners.

In some examples, the set of owners may comprise a hierarchical subset of owners that define a reporting chain for a particular component. For instance, a first owner of the hierarchical subset of owners may be an initial point of contact of the component, a second owner may be a supervisor for the initial point of contact, and/or the like. The range of owners within a hierarchical subset of owners may be enterprise specific (e.g., based on a service level agreement) and may escalate to a senior leaders in some enterprises. In some examples, the computing system 101 may provide a near-real time security alert 514 to a first owner of the hierarchical subset of owners. In some examples, the computing system 101 may provide escalation alerts to subsequent owners of the hierarchical subset of owners if a security vulnerability is still present and/or not acknowledges after an escalation time period. By way of example, the computing system 101 may detect an expiration of an escalation time period and, responsive to detecting the expiration of the escalation time period, the computing system 101 may provide an escalation alert to a subsequent owner of within the hierarchical subset of owners.

In some examples, the near real time security alert 514 and/or escalation alert may be initiated through a graph-based vulnerability dashboard that is powered by the vulnerability graph 412. An example dashboard is provided in FIG. 6 for illustration.

FIG. 6 depicts a vulnerability dashboard 600 for a graph-based vulnerability tracking approach in accordance with some embodiments of the present disclosure. As depicted, the vulnerability dashboard 600 may comprise a set of interactive widgets that may dynamically change over time to represent a current state within a computing ecosystem. As any given time, the vulnerability dashboard 600 may be updated with a first subset of the interactive widgets, a prioritized vulnerability widget subset 604a-c, that reflects a set of prioritized security vulnerabilities within the computing ecosystem based on the most recent scan results. In addition, or alternatively, the vulnerability dashboard 600 may comprise a second subset of the interactive widgets, an impacted software application subset 606a-b, which reflects a set of software applications impacted by the set of prioritized security vulnerabilities. In addition, or alternatively, the vulnerability dashboard 600 may comprise a third subset of the interactive widgets, ownership subset 608a-c, which reflects a set of owners for up to each of the impacted software applications. In some examples, up to each of the widgets may correspond to a node within the vulnerability graph, such that prediction of a particular widget may initiate a graph query and query response reflective of one or more attributes within a connected node. In this way, the vulnerability dashboard 600 may be dynamically updated using the vulnerability graph, while providing a query interface for improving access to data stored within the vulnerability graph. In some examples, the set of interactive widgets may further comprise a vulnerability query widget 610 to allow manual interaction with the vulnerability graph 412 (e.g., a manual security vulnerability detection).

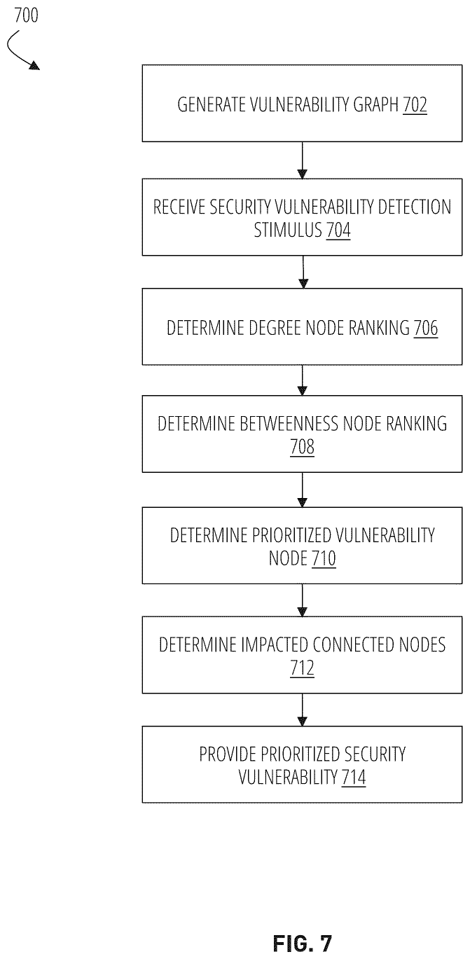

FIG. 7 depicts a flowchart diagram of vulnerability tracking process 700 in accordance with some embodiments of the present disclosure. The flow chart diagram depicts a graph-based vulnerability tracking approach that leverages new graph-based data structures and graph analysis techniques to improve computer security. The process 700 may be implemented by one or more computing devices, entities, and/or systems described herein. For example, via the various steps/operations of the process 700, the computing system 101 may construct and continuously modify a vulnerability graph to accurately represent a current vulnerability state of a computing ecosystem. By doing so, the process 700 improves computer security by enabling the software application of graph based analytical tools to vulnerability detection. This, in turn, may improve vulnerability detection and remediation speeds and, ultimately, the efficacy of vulnerability remediation in general.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, generating vulnerability graph. For example, the computing system 101 may generate the vulnerability graph from application data and/or ownership data for a computing ecosystem. The vulnerability graph may define a set of component nodes, a set of vulnerability nodes, and a set of graph edges for a computing ecosystem. The computing system 101 may initiate, at a scanning frequency, a vulnerability scan for the computing ecosystem and modify the vulnerability graph based on a scan result from the vulnerability scan. The scan result, for example, may comprise a unique vulnerability identifier, a unique component identifier, and/or a vulnerability description for a security vulnerability. The computing system 101 may modifying the vulnerability graph by determining a particular vulnerability node for the security vulnerability based on the unique vulnerability identifier and updating a subset of the set of graph edges that connects to the particular vulnerability node based on the unique component identifier.

In some embodiments, the process 700 comprises, at operation 704, receiving security vulnerability detection. For example, the computing system 101 may receive a security vulnerability detection for a computing ecosystem. In some examples, the computing system 101 may create or update the vulnerability graph for the computing ecosystem in response to the security vulnerability detection.

In some embodiments, the process 700 comprises, at operation 706, determining degree node ranking. For example, the computing system 101 may determine a degree measure for a vulnerability node of the plurality of vulnerability nodes within the vulnerability graph. The computing system 101 may generate a degree node ranking from the vulnerability graph based on a degree measure for up to each node of the set of vulnerability nodes.

In some examples, a component node of the set of component nodes comprises a risk weight that is based on a data access privilege of a software application corresponding to the component node. The computing system 101 may determine a set of weighted edge measurements for the vulnerability node and generate the degree measure by aggregating the set of weighted edge measurements. The set of weighted edge measurements may comprise a respective weight edge measurement for each of a subset of the set of graph edges connected to the vulnerability node. A weighted edge measurement of the set of weighted edge measurements may correspond to an edge that connects the vulnerability node to the component node. The weighted edge measurement may be based on the risk weight of the component node. In addition, or alternatively, a weighted edge measurement may be based on a data sensitivity of the data managed by a software application. In some examples, the weighted edge measurement may be based on a value impact of the software application. By way of example, a value impact may reflect a number of users that use the software application, a cost of use, a value (e.g., financial value, time saved) of use, and/or the like.

In some embodiments, the process 700 comprises, at operation 708, determining betweenness node ranking. For example, the computing system 101 may determine a betweenness measure for a vulnerability node of the plurality of vulnerability nodes within the vulnerability graph. For instance, the computing system 101 may determine a set of shortest paths between up to each pair of nodes within the vulnerability graph. The computing system 101 may determine a subset of the set of shortest paths that comprise the vulnerability node. The computing system 101 may determine the betweenness measure for the vulnerability node by dividing a first number of the subset of shortest paths that comprise the vulnerability node by a second number of the set of shortest paths between pairs of all nodes, with or without the vulnerability node in the path. The computing system 101 may generate a betweenness node ranking from the vulnerability graph based on a betweenness measure for up to each of the set of vulnerability nodes.

In some embodiments, the process 700 comprises, at operation 710, determining a set of prioritized vulnerability nodes. For example, the computing system 101 may determine a set of prioritized vulnerability nodes from the vulnerability graph based on the degree measure and the betweenness measure. In some examples, the computing system 101 may determine the set of prioritized vulnerability nodes from the vulnerability graph based on a first position of the set of prioritized vulnerability nodes within the degree node ranking and verify the set of prioritized vulnerability nodes based on a second position of the set of prioritized vulnerability nodes within the betweenness node ranking.

In some embodiments, the process 700 comprises, at operation 712, determining impacted component nodes. For example, the computing system 101 may traverse, via a breadth-first graph search from the set of prioritized vulnerability nodes, an initial subset of impacted component nodes from the set of component nodes. In some examples, the computing system 101 may remove at least one impacted component node from the initial subset of impacted component nodes based on a comparison between a risk weight of the at least one impacted component node and a risk threshold.

In some embodiments, the process 700 comprises, at operation 714, providing prioritized list of security vulnerabilities. For example, the computing system 101 may provide a prioritized list of security vulnerabilities for the computing ecosystem in response to the security vulnerability detection. For example, a component node of the set of component nodes may comprise an owner attribute. The computing system 101 may determine a subset of impacted component nodes from the set of component nodes based on a subset of the set of graph edges that respectively connect the set of prioritized vulnerability nodes to the subset of impacted component nodes. The computing system 101 may determine a set of owners for the prioritized list of security vulnerabilities based on the owner attribute of the component node and providing a near real time security alert that identifies the prioritized list of security vulnerabilities and at least one impacted application corresponding to the component node to at least one owner of the set of owners. In some examples, the computing system 101 may automatically initiate a vulnerability resolution action for the prioritized list of security vulnerabilities based on the impacted application and/or owner.

Some techniques of the present disclosure enable the generation of action outputs that may be performed to initiate one or more real world actions to achieve real-world effects. The techniques of the present disclosure may be used, applied, and/or otherwise leveraged to remediation actions, such as application reinstallation, updates, network reconfigurations, and/or the like. In some examples, the prioritized list of security vulnerabilities outputs of the present disclosure may trigger action outputs (e.g., through control instructions) to automate security actions and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), vulnerability remediation action (e.g., blocking traffic from impacted applications, dropping malicious network packets to/from impacted applications).

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, a security vulnerability detection for a computing ecosystem; determining, by the one or more processors, a vulnerability graph for the computing ecosystem that defines a set of component nodes, a set of vulnerability nodes, and a set of graph edges, wherein a first component node of the set of component nodes is associated with a discrete hardware or software component different from other components identified by remaining component nodes of the set of component nodes; determining, by the one or more processors, a degree measure and a betweenness measure for a vulnerability node of the set of vulnerability nodes within the vulnerability graph, wherein the degree measure quantifies a number of edges connected to the vulnerability node and the betweenness measure quantifies a number of shortest paths associated with the vulnerability node; determining, by the one or more processors, a set of prioritized vulnerability nodes from the vulnerability graph based on the degree measure and the betweenness measure; and providing, by the one or more processors, a prioritized list of security vulnerabilities for the computing ecosystem in response to the security vulnerability detection and based on the set of prioritized vulnerability nodes.

Example 2. The computer-implemented method of example 1, further comprising automatically initiating one or more vulnerability resolution actions for the prioritized list of security vulnerabilities.

Example 3. The computer-implemented method of any of the preceding examples, further comprising initiating, at a scanning frequency, a vulnerability scan for the computing ecosystem; and modifying the vulnerability graph based on a scan result from the vulnerability scan.

Example 4. The computer-implemented method of any of the preceding examples, wherein the scan result comprises a unique vulnerability identifier, a unique component identifier, and a vulnerability description for a security vulnerability, and modifying the vulnerability graph comprises determining a particular vulnerability node for the security vulnerability based on the unique vulnerability identifier; and updating a subset of the set of graph edges that connects to the particular vulnerability node based on the unique component identifier.

Example 5. The computer-implemented method of any of the preceding examples, wherein a component node of the set of component nodes comprises a risk weight that is based on at least one of: a data sensitivity or data access privilege of a software application corresponding to the component node, an exposure level of the software application corresponding to the component node, or a value outcome of a software application corresponding to the component node.

Example 6. The computer-implemented method of any of the preceding examples, wherein generating the degree measure for the vulnerability node comprises determining a set of weighted edge measurements for the vulnerability node, wherein (i) the set of weighted edge measurements comprises a respective weight edge measurement for each of a subset of the set of graph edges connected to the vulnerability node, (ii) a weighted edge measurement of the set of weighted edge measurements corresponds to an edge that connects the vulnerability node to the component node, and (iii) the weighted edge measurement is based on the risk weight of the component node; and generating the degree measure by aggregating the set of weighted edge measurements.

Example 7. The computer-implemented method of any of the preceding examples, wherein generating the betweenness measure for the vulnerability node comprises determining a set of shortest paths between pairs of nodes within the vulnerability graph; determining a subset of the set of shortest paths that comprise the vulnerability node; and determining the betweenness measure for the vulnerability node by dividing a first number of the subset of shortest paths that comprise the vulnerability node by a second number of the set of shortest paths between pairs of all nodes, with or without the vulnerability node in the path.

Example 8. The computer-implemented method of any of the preceding examples, wherein a component node of the set of component nodes comprises an owner attribute and the computer-implemented method further comprises determining a subset of impacted component nodes from the set of component nodes based on a subset of the set of graph edges that respectively connect the set of prioritized vulnerability nodes to the subset of impacted component nodes, wherein the subset of impacted component nodes comprises the component node; determining a set of owners for the prioritized list of security vulnerabilities based on the owner attribute of the component node; and providing a near-real time security alert that identifies at least one of the prioritized list of security vulnerabilities and a software application corresponding to the component node to at least one owner of the set of owners.

Example 9. The computer-implemented method of example 8, wherein determining the subset of impacted component nodes comprises traversing, via a breadth-first graph search from a prioritized vulnerability node of the set of prioritized vulnerability nodes, an initial subset of impacted component nodes from the set of component nodes; and removing at least one impacted component node from the initial subset of impacted component nodes based on a comparison between a risk weight of the at least one impacted component node and a risk threshold.

Example 10. The computer-implemented method of any of the preceding examples, wherein determining the set of prioritized vulnerability nodes from the vulnerability graph comprises generating (a) a degree node ranking from the vulnerability graph based on the degree measure and (b) a betweenness node ranking from the vulnerability graph based on the betweenness measure; determining the set of prioritized vulnerability nodes from the vulnerability graph based on a set of first positions respectively corresponding to the set of prioritized vulnerability nodes within the degree node ranking; and verifying the set of prioritized vulnerability nodes based on a set of second positions respectively corresponding to the set of prioritized vulnerability nodes within the betweenness node ranking.

Example 11. A system comprising one or more processors; and one or more memories storing processor-executable instructions that, when executed by the one or more processors, cause the one or more processors to perform operations comprising receiving a security vulnerability detection for a computing ecosystem; determining a vulnerability graph for the computing ecosystem that defines a set of component nodes, a set of vulnerability nodes, and a set of graph edges, wherein a first component node of the set of component nodes is associated with a discrete hardware or software component different from other components identified by remaining component nodes of the set of component nodes; determining a degree measure and a betweenness measure for a vulnerability node of the set of vulnerability nodes within the vulnerability graph; determining a set of prioritized vulnerability nodes from the vulnerability graph based on the degree measure and the betweenness measure; and providing a prioritized list of security vulnerabilities for the computing ecosystem in response to the security vulnerability detection and based on the set of prioritized vulnerability nodes.

Example 12. The system of example 11, wherein the scan result comprises a unique vulnerability identifier, a unique component identifier, and a vulnerability description for a security vulnerability, and modifying the vulnerability graph comprises determining a particular vulnerability node for the security vulnerability based on the unique vulnerability identifier; and updating a subset of the set of graph edges that connects to the particular vulnerability node based on the unique component identifier.

Example 13. The system of any of examples 11 through 12, wherein a component node of the set of component nodes comprises a risk weight that is based on a data access privilege of a software application corresponding to the component node.

Example 14. The system of any of examples 11 through 13, wherein generating the degree measure for the vulnerability node comprises determining a set of weighted edge measurements for the vulnerability node, wherein (i) the set of weighted edge measurements comprises a respective weight edge measurement for each of a subset of the set of graph edges connected to the vulnerability node, (ii) a weighted edge measurement of the set of weighted edge measurements corresponds to an edge that connects the vulnerability node to the component node, and generating the degree measure by aggregating the set of weighted edge measurements.

Example 15. The system of any of examples 11 through 14, wherein the weighted edge measurement is based on at least one of (i) the data sensitivity of a software application corresponding to the component node, (ii) an exposure level of the software application corresponding to the component node, or (iii) a value outcome of the software application corresponding to the component node.

Example 16. The system of any of examples 11 through 15, wherein generating a betweenness measure for the vulnerability node comprises determining a set of shortest paths between pairs of nodes within the vulnerability graph; determining a subset of the set of shortest paths that comprise the vulnerability node; and determining the betweenness measure for the vulnerability node by dividing a first number of the subset of shortest paths that comprise the vulnerability node by a second number of the set of shortest paths between pairs of all nodes, with or without the vulnerability node in the path.

Example 17. One or more non-transitory computer-readable media storing processor-executable instructions that, when executed by one or more processors, cause the one or more processors to perform operations comprising receiving a security vulnerability detection for a computing ecosystem; determining a vulnerability graph for the computing ecosystem that defines a set of component nodes, a set of vulnerability nodes, and a set of graph edges, wherein a first component node of the set of component nodes is associated with a discrete hardware or software component different from other components identified by remaining component nodes of the set of component nodes; determining a degree measure and a betweenness measure for a vulnerability node of the set of vulnerability nodes within the vulnerability graph; determining a set of prioritized vulnerability nodes from the vulnerability graph based on the degree measure and the betweenness measure; and providing a prioritized list of security vulnerabilities for the computing ecosystem in response to the security vulnerability detection and based on the set of prioritized vulnerability nodes.

Example 18. The one or more non-transitory computer-readable media of example 17, wherein a component node of the set of component nodes comprises an owner attribute and the operations further comprise determining a subset of impacted component nodes from the set of component nodes based on a subset of the set of graph edges that respectively connect the prioritized vulnerability node to the subset of impacted component nodes, wherein the subset of impacted component nodes comprises the component node; determining a set of owners for the prioritized security vulnerability based on the owner attribute of the component node; and providing a near-real time security alert that identifies the prioritized security vulnerability and an application corresponding to the component node to at least one owner of the set of owners.

Example 19. The one or more non-transitory computer-readable media of example 18, wherein the operations further comprise detecting an expiration of an escalation time period; and responsive to detecting the expiration of the escalation time period, providing an escalation alert to the at least one owner of the set of owners.

Example 20. The one or more non-transitory computer-readable media of example 19, wherein determining the subset of impacted component nodes comprises traversing, via a breadth-first graph search from the prioritized vulnerability node, an initial subset of impacted component nodes from the set of component nodes; and removing at least one impacted component node from the initial subset of impacted component nodes based on a comparison between a risk weight of the at least one impacted component node and an exposure threshold.

What is claimed is:

1. A computer-implemented method comprising:
receiving, by one or more processors, a security vulnerability detection for a computing ecosystem;
determining, by the one or more processors, a vulnerability graph for the computing ecosystem that defines a set of component nodes, a set of vulnerability nodes, and a set of graph edges, wherein a first component node of the set of component nodes is associated with a discrete hardware or software component different from other components identified by remaining component nodes of the set of component nodes;
determining, by the one or more processors, a degree measure and a betweenness measure for a vulnerability node of the set of vulnerability nodes within the vulnerability graph, wherein the degree measure quantifies a number of edges connected to the vulnerability node and the betweenness measure quantifies a number of shortest paths associated with the vulnerability node;
determining, by the one or more processors, a set of prioritized vulnerability nodes from the vulnerability graph based on the degree measure and the betweenness measure; and
providing, by the one or more processors, a prioritized list of security vulnerabilities for the computing ecosystem in response to the security vulnerability detection and based on the set of prioritized vulnerability nodes.

2. The computer-implemented method of claim 1, further comprising automatically initiating one or more vulnerability resolution actions for the prioritized list of security vulnerabilities.

3. The computer-implemented method of claim 1, further comprising:
initiating, at a scanning frequency, a vulnerability scan for the computing ecosystem; and
modifying the vulnerability graph based on a scan result from the vulnerability scan.

4. The computer-implemented method of claim 3, wherein the scan result comprises a unique vulnerability identifier, a unique component identifier, and a vulnerability description for a security vulnerability, and modifying the vulnerability graph comprises:
determining a particular vulnerability node for the security vulnerability based on the unique vulnerability identifier; and
updating a subset of the set of graph edges that connects to the particular vulnerability node based on the unique component identifier.

5. The computer-implemented method of claim 1, wherein a component node of the set of component nodes comprises a risk weight that is based on at least one of: a data sensitivity or data access privilege of a software application corresponding to the component node, an exposure level of the software application corresponding to the component node, or a value outcome of the software application corresponding to the component node.

6. The computer-implemented method of claim 5, wherein generating the degree measure for the vulnerability node comprises:
determining a set of weighted edge measurements for the vulnerability node, wherein:
(i) the set of weighted edge measurements comprises a respective weight edge measurement for each of a subset of the set of graph edges connected to the vulnerability node,
(ii) a weighted edge measurement of the set of weighted edge measurements corresponds to an edge that connects the vulnerability node to the component node, and
(iii) the weighted edge measurement is based on the risk weight of the component node; and
generating the degree measure by aggregating the set of weighted edge measurements.

7. The computer-implemented method of claim 1, wherein generating the betweenness measure for the vulnerability node comprises:
determining a set of shortest paths between pairs of nodes within the vulnerability graph;
determining a subset of the set of shortest paths that comprise the vulnerability node; and
determining the betweenness measure for the vulnerability node by dividing a first number of the subset of the set of shortest paths that comprise the vulnerability node by a second number of the set of shortest paths between pairs of all nodes.

8. The computer-implemented method of claim 1, wherein a component node of the set of component nodes comprises an owner attribute and the computer-implemented method further comprises:
determining a subset of impacted component nodes from the set of component nodes based on a subset of the set of graph edges that respectively connect the set of prioritized vulnerability nodes to the subset of impacted component nodes, wherein the subset of impacted component nodes comprises the component node;
determining a set of owners for the prioritized list of security vulnerabilities based on the owner attribute of the component node; and
providing a near-real time security alert that identifies at least one of the prioritized list of security vulnerabilities and a software application corresponding to the component node to at least one owner of the set of owners.

9. The computer-implemented method of claim 8, wherein determining the subset of impacted component nodes comprises:
traversing, via a breadth-first graph search from a prioritized vulnerability node of the set of prioritized vulnerability nodes, an initial subset of impacted component nodes from the set of component nodes; and
removing at least one impacted component node from the initial subset of impacted component nodes based on a comparison between a risk weight of the at least one impacted component node and a risk threshold.

10. The computer-implemented method of claim 1, wherein determining the set of prioritized vulnerability nodes from the vulnerability graph comprises:
generating (a) a degree node ranking from the vulnerability graph based on the degree measure and (b) a betweenness node ranking from the vulnerability graph based on the betweenness measure;
determining the set of prioritized vulnerability nodes from the vulnerability graph based on a set of first positions respectively corresponding to the set of prioritized vulnerability nodes within the degree node ranking; and
verifying the set of prioritized vulnerability nodes based on a set of second positions respectively corresponding to the set of prioritized vulnerability nodes within the betweenness node ranking.

11. A system comprising:
one or more processors; and
one or more memories storing processor-executable instructions that, when executed by the one or more processors, cause the one or more processors to perform operations comprising:
receiving a security vulnerability detection for a computing ecosystem;
determining a vulnerability graph for the computing ecosystem that defines a set of component nodes, a set of vulnerability nodes, and a set of graph edges, wherein a first component node of the set of component nodes is associated with a discrete hardware or software component different from other components identified by remaining component nodes of the set of component nodes;
determining a degree measure and a betweenness measure for a vulnerability node of the set of vulnerability nodes within the vulnerability graph;
determining a set of prioritized vulnerability nodes from the vulnerability graph based on the degree measure and the betweenness measure; and
providing a prioritized list of security vulnerabilities for the computing ecosystem in response to the security vulnerability detection and based on the set of prioritized vulnerability nodes.

12. The system of claim 11, wherein the operations further comprise:
initiating, at a scanning frequency, a vulnerability scan for the computing ecosystem; and
modifying the vulnerability graph based on a scan result from the vulnerability scan.

13. The system of claim 11, wherein a component node of the set of component nodes comprises a risk weight that is based on a data access privilege of a software application corresponding to the component node.

14. The system of claim 13, wherein generating the degree measure for the vulnerability node comprises:
determining a set of weighted edge measurements for the vulnerability node, wherein:
(i) the set of weighted edge measurements comprises a respective weight edge measurement for each of a subset of the set of graph edges connected to the vulnerability node,
(ii) a weighted edge measurement of the set of weighted edge measurements corresponds to an edge that connects the vulnerability node to the component node, and
generating the degree measure by aggregating the set of weighted edge measurements.

15. The system of claim 14, wherein the weighted edge measurement is based on at least one of (i) a data sensitivity of the software application corresponding to the component node, (ii) an exposure level of the software application corresponding to the component node, or (iii) a value outcome of the software application corresponding to the component node.

16. The system of claim 11, wherein generating the betweenness measure for the vulnerability node comprises:
determining a set of shortest paths between pairs of nodes within the vulnerability graph;
determining a subset of the set of shortest paths that comprise the vulnerability node; and
determining the betweenness measure for the vulnerability node by dividing a first number of the subset of the set of shortest paths that comprise the vulnerability node by a second number of the set of shortest paths between pairs of all nodes.

17. One or more non-transitory computer-readable media storing processor-executable instructions that, when executed by one or more processors, cause the one or more processors to perform operations comprising:
receiving a security vulnerability detection for a computing ecosystem;
determining a vulnerability graph for the computing ecosystem that defines a set of component nodes, a set of vulnerability nodes, and a set of graph edges, wherein a first component node of the set of component nodes is associated with a discrete hardware or software component different from other components identified by remaining component nodes of the set of component nodes;
determining a degree measure and a betweenness measure for a vulnerability node of the set of vulnerability nodes within the vulnerability graph;
determining a set of prioritized vulnerability nodes from the vulnerability graph based on the degree measure and the betweenness measure; and
providing a prioritized list of security vulnerabilities for the computing ecosystem in response to the security vulnerability detection and based on the set of prioritized vulnerability nodes.

18. The one or more non-transitory computer-readable media of claim 17, wherein a component node of the set of component nodes comprises an owner attribute and the operations further comprise:
determining a subset of impacted component nodes from the set of component nodes based on a subset of the set of graph edges that respectively connect a prioritized vulnerability node of the set of prioritized vulnerability nodes to the subset of impacted component nodes, wherein the subset of impacted component nodes comprises the component node;
determining a set of owners for a prioritized security vulnerability of the prioritized list of security vulnerabilities based on the owner attribute of the component node; and
providing a near-real time security alert that identifies the prioritized security vulnerability and an application corresponding to the component node to at least one owner of the set of owners.

19. The one or more non-transitory computer-readable media of claim 18, wherein the operations further comprise:
detecting an expiration of an escalation time period; and
responsive to detecting the expiration of the escalation time period, providing an escalation alert to the at least one owner of the set of owners.

20. The one or more non-transitory computer-readable media of claim 19, wherein determining the subset of impacted component nodes comprises:
traversing, via a breadth-first graph search from the prioritized vulnerability node, an initial subset of impacted component nodes from the set of component nodes; and
removing at least one impacted component node from the initial subset of impacted component nodes based on a comparison between a risk weight of the at least one impacted component node and an exposure threshold.
